(19) United States
(12) Patent Application Publication
(10) Pub. No.: US 2025/0225597 A1
(43) Pub. Date: Jul. 10, 2025

(54) BUILDING DATA PROCESSING DEVICE, BUILDING DATA PROCESSING METHOD, AND BUILDING DATA STRUCTURE

(71) Applicant: FUJIFILM Corporation, Tokyo (JP)

(72) Inventor: Kyota WATANABE, Tokyo (JP)

(73) Assignee: FUJIFILM Corporation, Tokyo (JP)

(21) Appl. No.: 19/090,044

(22) Filed: Mar. 25, 2025

Related U.S. Application Data
(63) Continuation of application No. PCT/JP2023/032835, filed on Sep. 8, 2023.

(30) Foreign Application Priority Data
Sep. 27, 2022 (JP) 2022-153367

(51) Int. Cl. G06Q 50/08; G06T 17/00

(52) U.S. Cl. CPC G06Q 50/08; G06T 17/00

(57) ABSTRACT

A building data processing device includes a memory that stores building data including identifiers, part information, and part relationship information; and a processor. The identifiers are to identify a plurality of parts constituting a building; the part information includes part types that indicate types of the plurality of parts associated with the identifiers, respectively, shape information that indicates three-dimensional shapes of the plurality of parts, and state information that indicates states of the plurality of parts; and the part relationship information indicates a relationship between the plurality of parts. The processor receives an input of a purpose of use of the building data, specifies a method of calculating information useful for the purpose of use based on the received purpose of use, and executes the specified method using the part information and the part relationship information stored in the memory to generate information useful for the purpose of use.

### CROSS-REFERENCE TO RELATED APPLICATIONS

The present application is a Continuation of PCT International Application No. PCT/JP2023/032835 filed on Sep. 8, 2023 claiming priority under 35 U.S.C § 119(a) to Japanese Patent Application No. 2022-153367 filed on Sep. 27, 2022. Each of the above applications is hereby expressly incorporated by reference, in its entirety, into the present application.

### BACKGROUND OF THE INVENTION

### 1. Field of the Invention

The present invention relates to a building data processing device, a building data processing method, and a building data structure, and particularly relates to a building data structure that can be used in a general-purpose manner for a plurality of purposes of use and a technique that generates information useful for a plurality of purposes of use from building data having the building data structure.

### 2. Description of the Related Art

There are a plurality of services related to the survey or assessment of a building as local government services, and information on dimensions or attributes of parts based on building drawings or the like is required for each service.

For example, in a residence damage certification survey service in a case of a disaster, local government officials visit the site and visually survey disaster-stricken buildings to create a drawing and to record damage for each part of the buildings. On the other hand, the same type of survey is also performed in a damage certification survey service provided by an insurance company. However, since damage aggregate criteria for each part of a building are different, building damage information created by the local government cannot be used as it is. Further, dimensions of each part are also measured in the survey of a building for fixed property tax assessment. However, particularly, detailed information on a calculation method, such as a net floor area and a centerline area, is required with regard to the area of a building. Since building information required for each purpose of a service includes common items and different items as described above, it is difficult to utilize static data such as drawing data, which is created in one service, for another service.

On the other hand, a damage survey system that can collect necessary information to allow even a person who does not have knowledge to determine the degree of damage to a disaster-stricken object to determine the degree of damage to a disaster-stricken object in a disaster-stricken area has been proposed (JP2018-165906A).

The damage survey system disclosed in JP2018-165906A includes a management server device that collects and manages information on a disaster-stricken object, and a portable terminal device that includes a display unit and a photographic unit and is connected to the management server device via a network. The portable terminal device comprises: a criterion designation unit that designates a criterion for the degree of damage to a disaster-stricken object; and a disaster-stricken object information transmission unit that transmits disaster-stricken object information, which includes image data of a captured photograph and the designated criterion for the degree of damage to the disaster-stricken object, from the portable terminal device to the management server device.

According to the damage survey system, even a person who does not have knowledge to determine the degree of damage to a disaster-stricken object can designate a criterion for the degree of damage, which is considered to correspond to a disaster-stricken object, with the criterion designation unit, capture a photograph of the disaster-stricken object with the photographic unit, and transmit disaster-stricken object information to the management server device with the disaster-stricken object information transmission unit, so that information required for certifying the degree of damage to the disaster-stricken object can be collected in the management server device.

Further, an earthquake damage evaluation device for a building that can be easily used by a person other than an expert has been proposed (JP2021-56139A).

The earthquake damage evaluation device for a building described in JP2021-56139A calculates an earthquake response based on building data and earthquake motion data; calculates a falling probability, a movement probability, and a moving distance based on the earthquake response, installation object data, and floor data; evaluates a falling risk based on the falling probability and evaluates a movement risk based on the movement probability and the moving distance; evaluates a non-structural part damage degree based on the earthquake response, the building data, and non-structural part data; evaluates a human damage occurrence probability based on the falling probability, the movement probability, the moving distance, the non-structural part damage degree, the installation object data, and room data; and evaluates an evacuation difficulty degree in a building based on the falling risk, the movement risk, and the non-structural part damage degree.

### SUMMARY OF THE INVENTION

The damage survey system disclosed in JP2018-165906A is a dedicated system that collects information required for certifying the degree of damage to a disaster-stricken object in a disaster-stricken area, and the earthquake damage evaluation device for a building disclosed in JP2021-56139A is also a dedicated device that evaluates a non-structural part damage degree, a human damage occurrence probability, and an evacuation difficulty degree in a building. That is, JP2018-165906A and JP2021-56139A do not disclose a building data structure that can be used in a general-purpose manner for a plurality of purposes of use, and do not disclose a technique that easily generates information useful for a plurality of purposes of use using building data having the building data structure.

The present invention has been made in view of such circumstances, and an object of the present invention is to provide a building data processing device and a building data processing method that can generate information useful for a plurality of purposes of use from a building data structure usable in a general-purpose manner for a plurality of purposes of use and building data having the building data structure, and to provide a building data structure.

In order to achieve the above object, according to a first aspect of the present invention, there is provided a building data processing device comprising a memory that stores building data including identifiers, part information, and part relationship information; and a processor. The identifiers are used to identify a plurality of parts constituting a building; the part information consists of part types indicating types of the plurality of parts associated with the identifiers, respectively, shape information indicating three-dimensional shapes of the plurality of parts, and state information indicating states of the plurality of parts; and the part relationship information indicates a relationship between the plurality of parts. The processor is configured to: receive an input of a purpose of use of the building data; specify a method of calculating information useful for the purpose of use based on the received purpose of use; and execute the specified method using the part information and the part relationship information stored in the memory to generate information useful for the purpose of use.

According to the first aspect of the present invention, in a case where the input of the purpose of use of the building data is received, a method of calculating information useful for the purpose of use based on the received purpose of use is specified and the specified method is executed using the part information and the part relationship information stored in the memory to generate information useful for the purpose of use. Therefore, a user can easily acquire the information useful for the purpose of use.

According to a second aspect of the present invention, in the building data processing device according to the first aspect, it is preferable that the part types include information indicating one or more parts of an exterior wall, an interior wall, a roof, a foundation, a column, a beam, a floor, a ceiling, a building fixture, and equipment.

According to a third aspect of the present invention, in the building data processing device according to the first aspect, it is preferable that the part relationship information includes information indicating one or more relationships of an aggregation relationship that indicates a relationship between a first part and a second part of a substructure of the first part, a dependency relationship that indicates a relationship between a first part and a second part in a case where the first part depends on a structure of the second part, an adjacency relationship that indicates a relationship between a first part and a second part in a case where the first part and the second part of the same type are adjacent to each other, a possession relationship that indicates a relationship between a first part and a second part in a case where the first part possesses the second part as a component, and a time-series relationship that is related to a history of the same part associated with extension/reconstruction.

According to a fourth aspect of the present invention, in the building data processing device according to the first aspect, it is preferable that the state information includes a damage type, a damage size, a degree of damage, a flood depth, an inspector comment, or an image.

According to a fifth aspect of the present invention, in the building data processing device according to the first aspect, it is preferable that the building data of a building to be surveyed includes information on a disaster-stricken building that has been struck by a disaster in a vicinity of the building to be surveyed.

According to a sixth aspect of the present invention, in the building data processing device according to the first aspect, it is preferable that the purpose of use includes one or more purposes of a residence damage certification survey service, a fixed property tax survey service, an urban planning service, and a vacant house management service.

According to a seventh aspect of the present invention, in the building data processing device according to any one of the first to sixth aspects, the processor is configured to store the generated information in the memory in association with the identifiers corresponding to the parts as the state information of the parts.

According to the seventh aspect of the present invention, in a case where information useful for the purpose of use is generated in relation to a part, the generated information is stored in the memory as the state information of the part in association with an identifier corresponding to the part.

According to an eighth aspect of the present invention, in the building data processing device according to the first aspect, the processor is configured to: specify a method of calculating building damage information useful for a residence damage certification survey service of a building received as the purpose of use of the building data in a case where the processor receives the residence damage certification survey service as the purpose of use of the building data; receive an input of an instruction to display or not display each part of the building and cause a display unit to display the part for which the input of the instruction is received, dimensions of the part, and the state information; and execute the specified method using the part information and the part relationship information corresponding to the part displayed on the display unit to generate building damage information that is the state information.

According to a ninth aspect of the present invention, in the building data processing device according to the eighth aspect, it is preferable that the building damage information includes information indicating a damage image, a damage size, a ratio of an area occupied by damage, or a flood depth.

According to a tenth aspect of the present invention, in the building data processing device according to the ninth aspect, it is preferable that the processor is configured to receive a degree of damage, which is input by a user, for each damage, and the building damage information includes the degree of damage.

According to an eleventh aspect of the present invention, in the building data processing device according to the first aspect, the processor is configured to: specify a method of calculating a floor area useful for a fixed property tax survey service of a building received as the purpose of use of the building data in a case where the processor receives the fixed property tax survey service as the purpose of use of the building data; cause a display unit to display an extension/reconstruction history of the building based on a time-series relationship included in the part relationship information; cause the display unit to display the part and the state information based on the part information associated with a switched history in a case where the processor receives switching of a history from the extension/reconstruction history displayed on the display unit; and execute the specified method of calculating the floor area using the part information and the part relationship information corresponding to the part displayed on the display unit to generate the floor area that is the state information.

According to a twelfth aspect of the present invention, there is provided a building data processing method executed by a processor of a building data processing device including a memory that stores building data including identifiers, part information, and part relationship information, and a processor. The identifiers are used to identify a plurality of parts constituting a building; the part information consists of part types indicating types of the plurality of parts associated with the identifiers, respectively, shape information indicating three-dimensional shapes of the plurality of parts, and state information indicating states of the plurality of parts; and the part relationship information indicates a relationship between the plurality of parts. The building data processing method comprises a step of receiving an input of a purpose of use of the building data, a step of specifying a method of calculating information useful for the purpose of use based on the received purpose of use, and a step of executing the specified method using the part information and the part relationship information stored in the memory to generate information useful for the purpose of use.

According to a thirteenth aspect of the present invention, the building data processing method according to the twelfth aspect further comprises: a step of receiving a residence damage certification survey service of a building as the purpose of use of the building data; a step of specifying a method of calculating building damage information useful for the received residence damage certification survey service; a step of receiving an input of an instruction to display or not display each part of the building and causing a display unit to display the part for which the input of the instruction is received, dimensions of the part, and the state information; and a step of executing the specified method using the part information and the part relationship information corresponding to the part displayed on the display unit to generate building damage information that is the state information.

According to a fourteenth aspect of the present invention, the building data processing method according to the twelfth aspect further comprises: a step of receiving a fixed property tax survey service of a building as the purpose of use of the building data; a step of specifying a method of calculating a floor area useful for the received fixed property tax survey service; a step of causing a display unit to display an extension/reconstruction history of each part of the building based on a time-series relationship included in the part relationship information; a step of causing the display unit to display the part and the state information based on the part information associated with a switched history in a case where switching of a history is received from the extension/reconstruction history displayed on the display unit; and a step of executing the specified method of calculating the floor area using the part information and the part relationship information corresponding to the part displayed on the display unit to generate the floor area that is the state information.

According to a fifteenth aspect of the present invention, there is provided a building data structure comprising: identifiers that are used to identify a plurality of parts constituting a building; part information that consists of part types indicating types of the plurality of parts associated with the identifiers, respectively, shape information indicating three-dimensional shapes of the plurality of parts, and state information indicating states of the plurality of parts; and part relationship information that indicates a relationship between the plurality of parts. The building data structure is represented as a valid graph in which the part information corresponds to nodes and the part relationship information corresponds to edges.

According to a sixteenth aspect of the present invention, in the building data structure according to the fifteenth aspect, it is preferable that the part types include information indicating one or more parts of an exterior wall, an interior wall, a roof, a foundation, a column, a beam, a floor, a ceiling, a building fixture, and equipment.

According to a seventeenth aspect of the present invention, in the building data structure according to the fifteenth aspect, it is preferable that the part relationship information includes information indicating one or more relationships of an aggregation relationship that indicates a relationship between a first part and a second part of a substructure of the first part, a dependency relationship that indicates a relationship between a first part and a second part in a case where the first part depends on a structure of the second part, an adjacency relationship that indicates a relationship between a first part and a second part in a case where the first part and the second part of the same type are adjacent to each other, a possession relationship that indicates a relationship between a first part and a second part in a case where the first part possesses the second part as a component, and a time-series relationship that is related to a history of the same part associated with extension/reconstruction.

According to an eighteenth aspect of the present invention, in the building data structure according to the fifteenth aspect, it is preferable that the state information includes a damage type, a damage size, a degree of damage, a flood depth, an inspector comment, or an image.

According to the present invention, it is possible to provide a building data structure that can be used in a general-purpose manner for a plurality of purposes of use. Further, since building data having the building data structure is used, even a non-skilled person can acquire information useful for a plurality of purposes of use with a simple selection operation.

### BRIEF DESCRIPTION OF THE DRAWINGS

FIG. 1 is a diagram showing an appearance of a building that is created using a modeling tool applied to a building data structure.

FIG. 2 is a diagram showing an embodiment of a building data structure of the building shown in FIG. 1.

FIG. 3 is a system configuration diagram showing a building data processing system that includes a building data processing device according to an embodiment of the present invention and a server.

FIG. 4 is a functional block diagram showing the building data processing device according to the embodiment of the present invention.

FIGS. 5A and 5B are diagrams showing an example of a part of a building displayed on a display unit.

FIG. 6 is a front view of exterior walls of the building shown in FIG. 5B.

FIG. 7 is a diagram showing an example of a screen that shows an extension/reconstruction history displayed on the display unit.

(A) and (B) of FIG. 8 are diagrams showing the switching of a history from a newly constructed building to a reconstructed building.

FIG. 9 is a diagram showing an example of display of a floor area.

FIG. 10 is a diagram showing an appearance of the building in a case where a roof and an exterior wall of the building shown in FIG. 1 are damaged.

FIG. 11 is a diagram showing a building data structure in which state information of a part acquired subsequently is associated with the building data structure shown in FIG. 2.

FIGS. 12A and 12B are diagrams showing an example of building data and a drawing of a building displayed based on the building data.

FIGS. 13A and 13B are conceptual diagrams showing a centerline area and a net floor area.

FIG. 14 is a diagram in which a building including four columns and interior walls shown in FIGS. 13A and 13B is modeled based on part information and part relationship information.

FIG. 15 is a diagram used to describe a method of extracting four interior walls forming a floor area from the modeled diagram shown in FIG. 14.

FIG. 16 is a diagram used to describe a method of calculating a centerline of each interior wall using part information of the extracted four interior walls (vertex polygon).

FIG. 17 is a diagram used to describe a method of specifying pairs of interior walls, which are in an “adjacency relationship”, of the extracted four interior walls and a method of calculating intersections between the centerlines of the pairs of interior walls.

FIG. 18 is a schematic diagram of interior walls that form a floor area used to calculate a net floor area.

FIG. 19 is a diagram used to describe a method of specifying pairs of interior walls, which are in an “adjacency relationship”, of the extracted four interior walls and a method of calculating intersections between inner diameter lines of the pairs of interior walls.

FIG. 20 is a diagram used to describe a method of calculating an interior wall area using coordinates of the intersections between the four inner diameter lines.

FIG. 21 is a diagram used to describe a method of extracting parts (columns) interposed in the “adjacency relationship” from the “adjacency relationship” of the specified pairs of interior walls and a method of acquiring coordinates of inner diameter-side vertices of the extracted columns.

FIG. 22 is a diagram used to describe a method of calculating an inner diameter-column area from the coordinates of the inner diameter-side vertex of the column and the coordinates of the intersection between the inner diameter lines of the pair of interior walls.

FIG. 23 is a flowchart showing a building data processing method according to an embodiment of the present invention.

### DESCRIPTION OF THE PREFERRED EMBODIMENTS

A building data processing device, a building data processing method, and a building data structure according to preferred embodiments of the present invention will be described below with reference to the accompanying drawings.

### Building Data Structure

The building data structure according to the embodiment of the present invention will be described.

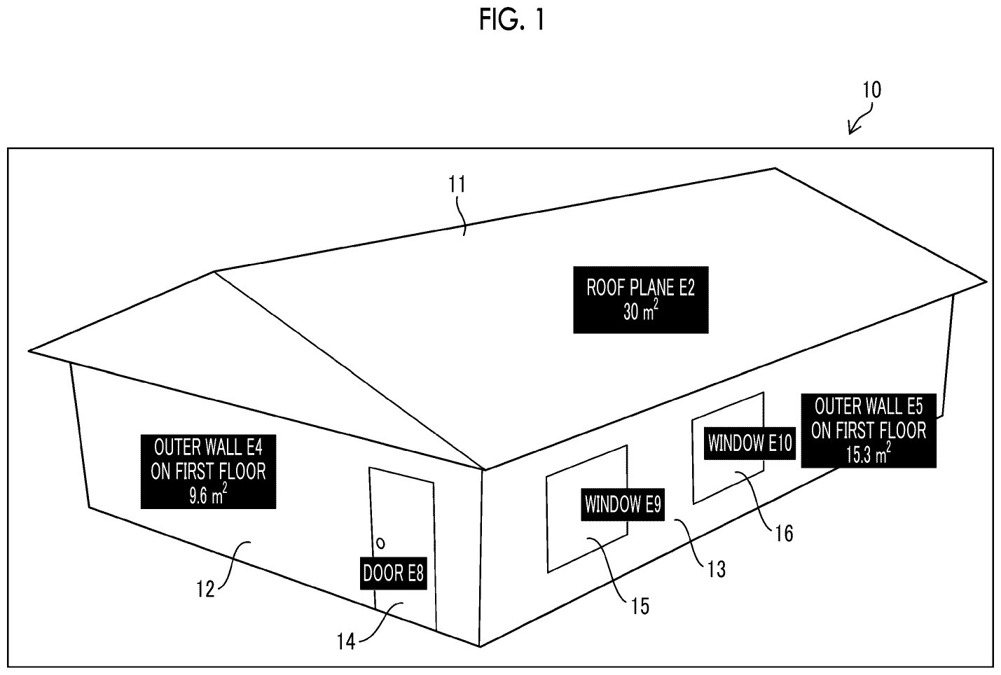

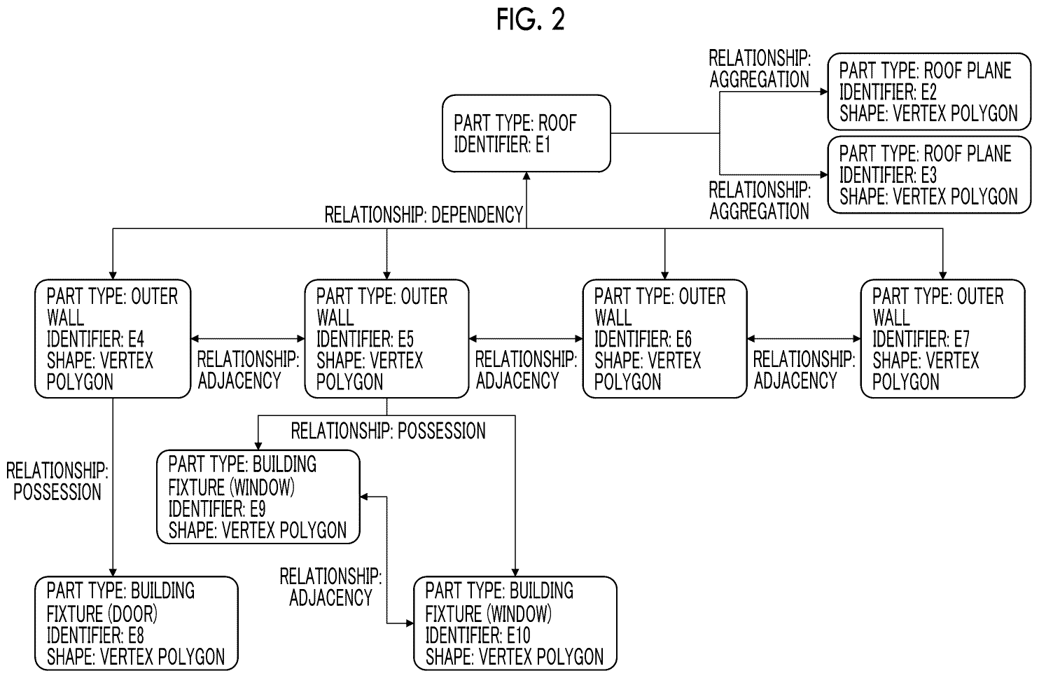

FIG. 1 is a diagram showing an appearance of a building that is created using a modeling tool applied to the building data structure, and FIG. 2 is a diagram showing an embodiment of the building data structure of the building shown in FIG. 1.

The building 10 shown in FIG. 1 includes a plurality of parts that include a roof 11, four exterior walls including exterior walls 12 and 13, a door 14 disposed on the exterior wall 12, and two windows 15 and 16 disposed on the exterior wall 13.

As shown in FIGS. 1 and 2, the building data structure comprises: identifiers that are used to identify a plurality of parts constituting the building 10; part information that consists of part types indicating the types of the plurality of parts associated with the identifiers, respectively, shape information indicating three-dimensional shapes of the plurality of parts, and state information indicating the states of the plurality of parts; and part relationship information that indicates a relationship between the plurality of parts. The building data structure is represented as a valid graph in which the part information corresponds to nodes and the part relationship information corresponds to edges.

The identifiers (for example, E1 to E10) used to identify the parts are assigned to the plurality of parts constituting the building 10. In a case where there are four exterior walls as the parts constituting the building 10, different identifiers (E4 to E7) are assigned to the respective four exterior walls.

The part types indicating the types of the plurality of parts associated with the identifiers include, for example, information indicating one or more parts of an exterior wall, an interior wall, a roof, a foundation, a column, a beam, a floor, a ceiling, a building fixture, and equipment.

Further, the shape information indicating the three-dimensional shapes of the plurality of parts associated with the identifiers can be, for example, three-dimensional data of vertices of a polygon (hereinafter, referred to as “polygon data”) in a case where the shape of the part is a polygonal shape. The polygon data for each part can be created using a modeling tool.

The state information indicating the states of the plurality of parts includes a damage type, a damage size, a degree of damage, a flood depth, an inspector comment, or an image. The image is a damage image in which a damage range of a building (house) is imaged. The state information includes information that can be prepared in advance, such as a damage image, information that is calculated by a method of calculating information useful for a purpose of use, and information that is subsequently generated and input, such as information input by a user.

The part information includes part types, shape information, and state information associated with the identifiers.

Further, the building data structure comprises part relationship information that indicates a relationship between the plurality of parts.

The part relationship information includes information that indicates one or more relationships of an aggregation relationship, a dependency relationship, an adjacency relationship, a possession relationship, and a time-series relationship.

Here, the aggregation relationship refers to a relationship between a first part and a second part of a substructure of the first part. For example, in a case where a part type is “roof 11” and two “roof planes” of a substructure are present with respect to the “roof 11”, the “roof 11” and the two “roof planes” are in the aggregation relationship.

The dependency relationship refers to a relationship between a first part and a second part in a case where the first part depends on a structure of the second part. For example, in a case where the first part is “roof 11” and the “roof 11” is provided on four “exterior walls 12, 13, and the like” as the second part, the “roof 11” as the first part depends on the structure of the four “exterior walls 12, 13, and the like” as the second part. Further, conversely, in a case where the first part is four “exterior walls 12, 13, and the like” and the second part is “roof 11”, the four “exterior walls 12, 13, and the like” as the first part depend on the “roof 11” as the second part. That is, the “roof 11” and the four “exterior walls 12, 13, and the like” are in a mutual dependency relationship.

The adjacency relationship refers to a relationship between a first part and a second part in a case where the first part and the second part of the same type are adjacent to each other. For example, adjacent exterior walls (for example, the exterior wall 12 and the exterior wall 13) of the four exterior walls are in a mutually adjacency relationship. Further, two adjacent windows 15 and 16 provided on the same exterior wall 13 are also in a mutual adjacency relationship.

The possession relationship refers to a relationship between a first part and a second part in a case where the first part possesses the second part as a component. For example, in a case where the first part is “exterior wall 12” and the second part is “door 14” as a building fixture provided on the “exterior wall 12”, the first part and the second part are in a possession relationship in which the “exterior wall 12” possesses the “door 14”. In a case where the first part is “exterior wall 13” and the second part is “windows 15 and 16” as a building fixture provided on the “exterior wall 13”, the first part and the second part are in a possession relationship in which the “exterior wall 13” possesses the “windows 15 and 16”.

The time-series relationship refers to, for example, a relationship regarding a history of the same part associated with extension/reconstruction. In a case where a newly constructed first part is “floor” and a second part after extension/reconstruction is “floor” that is obtained from the extension/reconstruction of the “floor” as the newly constructed first part, the “floor” as the newly constructed first part and the “floor” as the second part after extension/reconstruction are in the time-series relationship.

Further, as shown in FIG. 2, the building data structure is represented as a valid graph in which “part information” of respective parts of a building, which includes part types, shape information, state information associated with the identifiers, and the like, corresponds to nodes and “part relationship information” of an aggregation relationship, a dependency relationship, an adjacency relationship, a possession relationship, a time-series relationship, and the like corresponds to edges.

The building data structure of a building to be surveyed may include information on a disaster-stricken building that has been struck by a disaster in the vicinity.

### Building Data Processing System

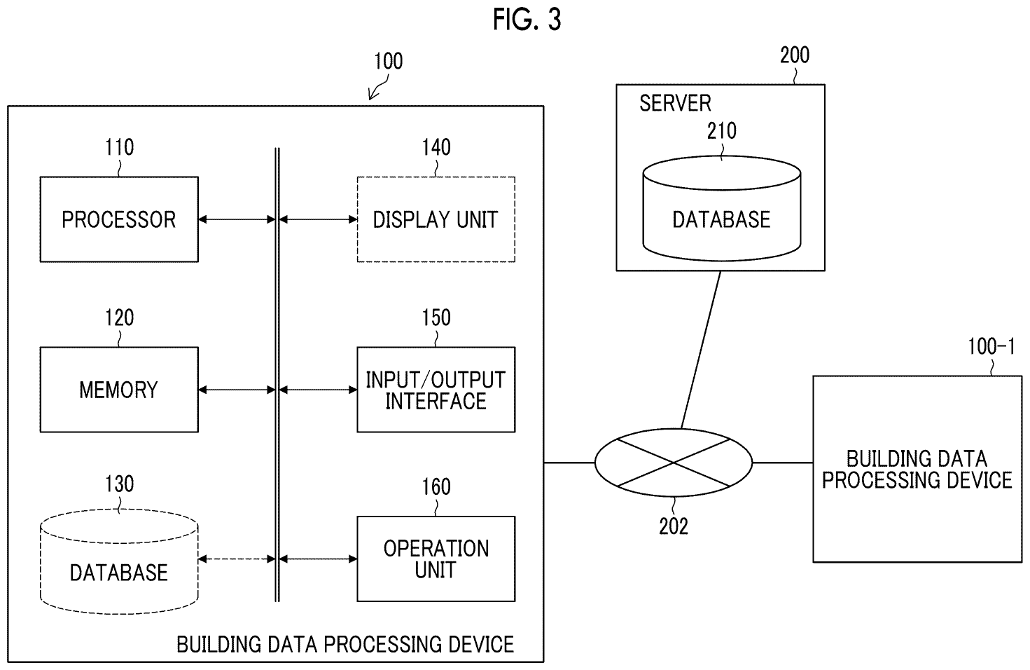

FIG. 3 is a system configuration diagram showing a building data processing system that includes the building data processing device according to the embodiment of the present invention and a server.

As shown in FIG. 3, the building data processing system is adapted such that building data processing devices 100 and 100-1 and a server 200 can communicate with each other through a network 202.

The building data processing devices 100 and 100-1 are computers of a disaster prevention division, a property tax division, and the like of a local government. The building data processing devices 100 and 100-1 may be computers of other business operators (for example, insurance companies), and the number of building data processing devices 100 and 100-1 that can be connected to the server 200 is not limited to two as shown in FIG. 3.

The server 200 is, for example, a server of a local government and comprises a database 210 that stores building data of a building under the jurisdiction of the local government. The building data managed by the database 210 has a building data structure as shown in FIG. 2.

### Hardware Configuration of Building Data Processing Device

Hardware of the building data processing device 100 configured of a computer comprises a processor 110, a memory 120, a database 130, a display unit 140, an input/output interface 150, and an operation unit 160.

The processor 110 is configured of a central processing unit (CPU) and the like, executes various programs including an operating system stored in the memory 120, generally controls each part of the building data processing device 100, and executes calculation, display control, and the like to be described later.

The memory 120 includes a flash memory, a read-only memory (ROM), a random access memory (RAM), a hard disk drive, and the like. The flash memory, the ROM, or the hard disk drive is a non-volatile memory that stores various programs including an operating system and a modeling tool (three-dimensional modeling software) applied to the building data structure. The RAM functions as a work area for processing performed by the processor 110 and temporarily stores the programs and the like stored in the flash memory and the like. Meanwhile, a part (RAM) of the memory 120 may be built in the processor 110. Further, the memory 120 may store building data, building damage information, and the like.

The database 130 can be the same database as the database 210 of the server 200. In this case, the building data processing device 100 does not need to communicate with the server 200. Further, in a case where the database 210 of the server 200 is used, the database 130 can be omitted.

The display unit 140 displays a necessary drawing of the building in response to an instruction given from the processor 110 or is also used as a part of a Graphical User Interface (GUI) in a case where various types of information are received from the operation unit 160.

The display unit 140 may be included in the building data processing device 100 in a case where the building data processing device 100 is configured of a tablet terminal or a laptop computer, or may be an external display unit connected to the building data processing device 100 in a case where the building data processing device 100 is configured of a desktop personal computer.

The input/output interface 150 includes a connection unit that can be connected to an external device, a communication unit that can be connected to a network, and the like. A universal serial bus (USB), a high-definition multimedia interface (HDMI) (HDMI is a registered trademark), or the like can be applied as the connection unit that can be connected to the external device. The processor 110 can exchange necessary data with the server 200 or other external devices via the input/output interface 150.

The operation unit 160 includes a pointing device such as a mouse, a keyboard, and the like, and uses a display screen of the display unit 140 to function as a part of the GUI that receives the input of various types of information and the input of instructions performed by user operations.

### Building Data Processing Device According to Embodiment

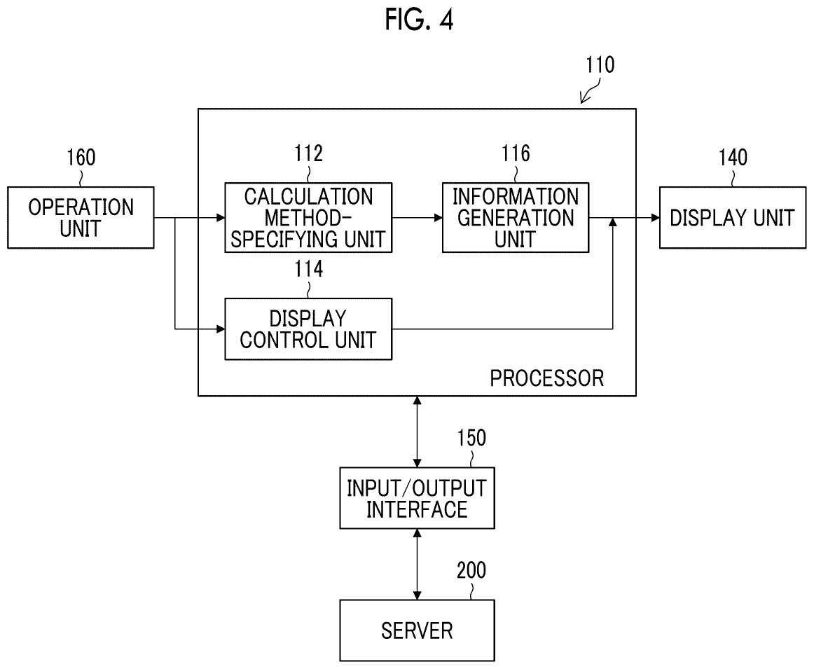

FIG. 4 is a functional block diagram showing the building data processing device according to the embodiment of the present invention.

FIG. 4 is a functional block diagram mainly showing functions of the processor 110 of the building data processing device 100 shown in FIG. 3.

In FIG. 4, the processor 110 functions as a calculation method-specifying unit 112, a display control unit 114, and an information generation unit 116.

First, the processor 110 acquires building data of the building to be surveyed from the server 200 via the input/output interface 150 in response to an instruction input from the operation unit 160, and temporarily stores the building data in the memory 120.

The calculation method-specifying unit 112 receives an input of a purpose of use of the building data from the operation unit 160, and specifies a method of calculating information useful for the purpose of use based on the received purpose of use. Here, the purpose of use of the building data includes one or more purposes of a residence damage certification survey service, a fixed property tax survey service, an urban planning service, and a vacant house management service. Even in the same purpose of a service, there may be a case where it is effective that a method of calculating the same part information is switched since criteria can be changed due to the amendment or the like of relevant statutory provisions for the service. In particular, criteria of damage are frequently changed due to a change in a guideline of a country in the residence damage certification survey service. Accordingly, a difference in the version of the guideline is interpreted as a difference in a purpose and is added to the specifying of calculation, so that an effect helping to improve explainability such as comparison between new and old results can be obtained.

### Purpose of Residence Damage Certification Survey Service

Next, a case where an input of a purpose of the residence damage certification survey service is received as the purpose of use of the building data will be described.

In the residence damage certification survey in a case of a disaster, dimensions of each part, a damage size (the area of damage), and a ratio of an area occupied by damage are calculated for each part of a disaster-stricken building.

The display control unit 114 receives the input of an instruction to display or not display each part of the building from the operation unit 160, and causes the display unit 140 to display the part for which the input of the instruction is received, the dimensions of the part, and state information. That is, the display control unit 114 executes the modeling tool using the building data stored in the memory 120 to cause the display unit 140 to display a part for which the input of an instruction to display each part of the building is received from the operation unit 160.

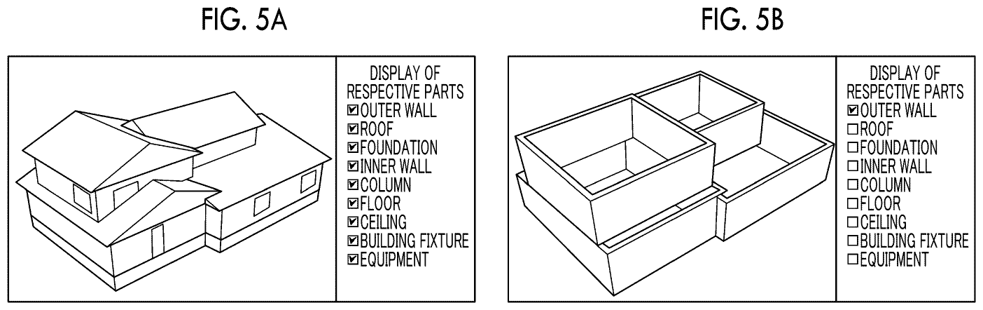

FIGS. 5A and 5B are diagrams showing an example of the part of the building displayed on the display unit.

FIG. 5A shows an example of display in a case where all check boxes for display of the respective parts of the building are checked (that is, in a case where the display of all the parts is instructed), and FIG. 5B shows an example of display in a case where only “exterior wall” is checked among the check boxes for display of the respective parts of the building is checked.

Since the building data includes the part types of the respective parts constituting the building, the shape information (vertex polygon) that indicates the three-dimensional shapes of the parts, and the part relationship information that indicates a relationship between the respective parts, the display control unit 114 can combine the respective parts using the shape information and the part relationship information of the respective parts to cause the display unit 140 to display a part desired by a user.

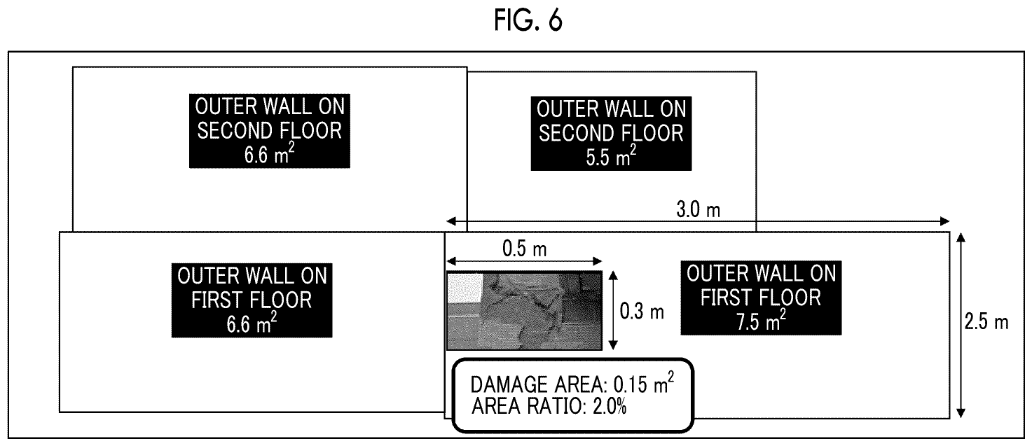

FIG. 6 is a front view of the exterior walls of the building shown in FIG. 5B. The display control unit 114 can arbitrarily enlarge, reduce, translate, or rotate the drawing of the part displayed on the display unit 140 in response to an instruction input from the operation unit 160. A front view of two exterior walls of a first floor and two exterior walls of the second floor is displayed in FIG. 6.

The information generation unit 116 can calculate the dimensions and the area of each exterior wall based on the shape information (vertex polygon) of each exterior wall and causes the display unit 140 to display the dimensions and the area.

Further, in a case where an image of a part is included as the state information indicating the state of the part, the display control unit 114 superimposes the image on the drawing of the corresponding part and displays the image superimposed on the drawing. In the example shown in FIG. 6, the right exterior wall of the first floor in FIG. 6 is damaged. A user (inspector) can input an image (damage image) in which a damaged portion is imaged as state information indicating a state of the damaged part. That is, the damage image is information included in the state information of the part, is data in which only a damaged portion is imaged in advance, and is treated as a part of input data. In this case, the dimensions of the damage and the position data of the damage are also input together with the damage image as the state information of the part by the inspector. The dimensions of the damage indicated by the damage image shown in FIG. 6 are 0.3 m in length and 0.5 m in width.

However, “image size” as the number of pixels in a case where the damage image is displayed on the display unit 140 is automatically calculated by the display control unit 114. For example, in a case where the input dimension of the damage is 1 meter, the display control unit 114 draws a damage image size with 100 pixels, for example, as 1 pixel per centimeter. The inspector can appropriately move the damage image on the display screen to input position data of the damage image.

The information generation unit 116 calculates a damage size and an area ratio of a damage area to the area of a part and causes the display unit 140 to display calculation results. In the present example, since the area of the damaged right exterior wall of the first floor shown in FIG. 6 is 7.5 m² (=2.5×3.0) and the damage area is 0.15 m² (=0.3×0.5), the area ratio is 2.0% (=(0.15/7.5)×100). The information generation unit 116 also executes the calculation of a distance between the damage portion and a peripheral part.

The inspector can certify the degree of damage from the damage size of the part and the area ratio, and input the certified degree of damage.

The damage size (damage area) and the area ratio calculated in this way are added as the state information (building damage information) of the corresponding part. Further, the processor 110 receives the degree of damage for each damaged part that is input by the user (input by the inspector), and information on the received degree of damage is added as the state information (building damage information) of the corresponding part. The inspector can further input a damage type (for example, peeling or cracking) of the part and an inspector comment, and can input a flood depth or the like as the state information of the part in a case where damage to the building is flood.

Accordingly, the information generation unit 116 can generate information (a damage area, an area ratio, and the like) useful for the residence damage certification survey service, causes the display unit 140 to display the generated information, and records the generated information in association with the building data.

### Purpose of Fixed Property Tax Survey Service

Next, a case where an input of a purpose of the fixed property tax survey service is received as the purpose of use of the building data will be described.

In the fixed property tax survey service of the building, it is necessary to obtain a floor area as one of the fixed property tax assessments.

Now, a case where the building data of the building to be surveyed stored in the memory 120 has a time-series relationship regarding a history of the same part associated with extension/reconstruction as the part relationship information will be described.

The display control unit 114 receives the input of an instruction to display or not display each part of the building from the operation unit 160, and causes the display unit 140 to display the part for which the input of the instruction is received, the dimensions of the part, and state information. However, in a case where the building data has a time-series relationship as the part relationship information, the display control unit 114 further receives an input of reconstruction, new construction, or the like from the inspector, and causes the display unit 140 to display the part information of a newly constructed part or a reconstructed part.

In a case where the building data has a time-series relationship as the part relationship information, the display control unit 114 causes the display unit 140 to display an extension/reconstruction history of the building.

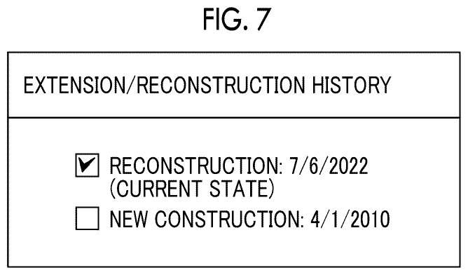

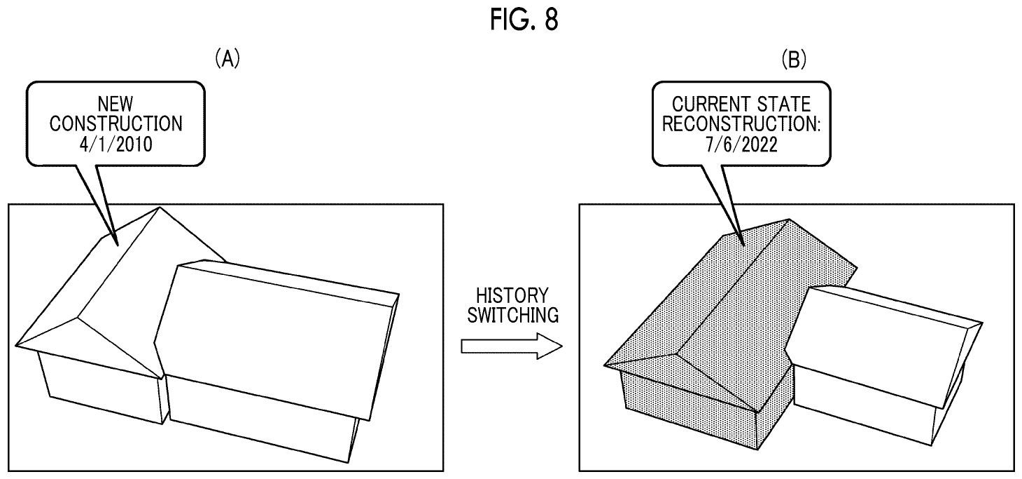

FIG. 7 is a diagram showing an example of a screen showing the extension/reconstruction history displayed on the display unit.

The inspector uses the screen of the display unit 140, which shows the extension/reconstruction history shown in FIG. 7, and the operation unit 160 to select reconstruction or new construction.

In a case where the display control unit 114 receives the switching of a history of reconstruction or new construction from the extension/reconstruction history displayed on the display unit 140, the display control unit 114 causes the display unit 140 to display the part and the state information based on the part information associated with the switched history.

For example, in a case where a history is switched from new construction to reconstruction, the display screen of the display unit 140 is switched from a drawing of a newly constructed building to a drawing of a reconstructed building.

(A) and (B) of FIG. 8 are diagrams showing the switching of a history from a newly constructed building to a reconstructed building. (A) of FIG. 8 shows a drawing of a newly constructed building, and (B) of FIG. 8 shows a drawing of a reconstructed building. In particular, a portion shown in gray in (B) of FIG. 8 indicates a reconstructed portion.

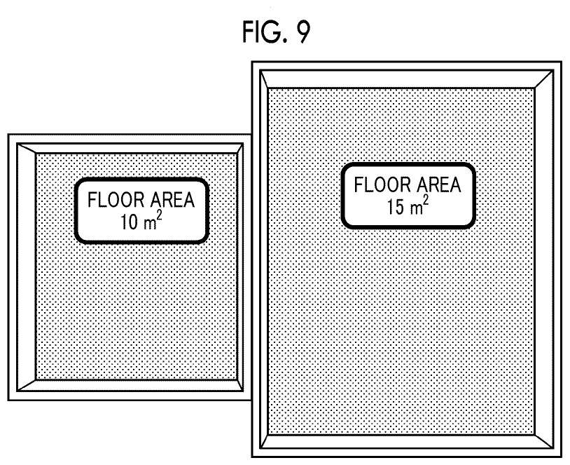

FIG. 9 is a diagram showing an example of display of a floor area.

In a case where the calculation method-specifying unit 112 receives an input of a purpose of the fixed property tax survey service from the operation unit 160 as the purpose of use of the building data, the calculation method-specifying unit 112 specifies the calculation method of calculating a floor area and the information generation unit 116 executes the specified calculation method using the building data (the part information and the part relationship information) of the building to be surveyed stored in the memory 120 to calculate a floor area useful for the purpose of the fixed property tax survey service.

The information generation unit 116 specifies sizes of the floor in a vertical direction and a horizontal direction from, for example, shape information (vertex polygon) of four walls (exterior walls/interior walls) having a mutual adjacency relationship, and calculates the floor area. There are a case where a floor area is calculated for each compartment such as a room, a case where a floor area of each floor including a room, a bathroom, a restroom, a corridor, and the like is calculated, and the like. Accordingly, a floor area is calculated according to a method of calculating a floor area of a local government.

The information generation unit 116 can display the floor area, which is calculated in this way, on the display unit 140 and can record the floor area in association with the building data.

### Recording of Damage for Each Part

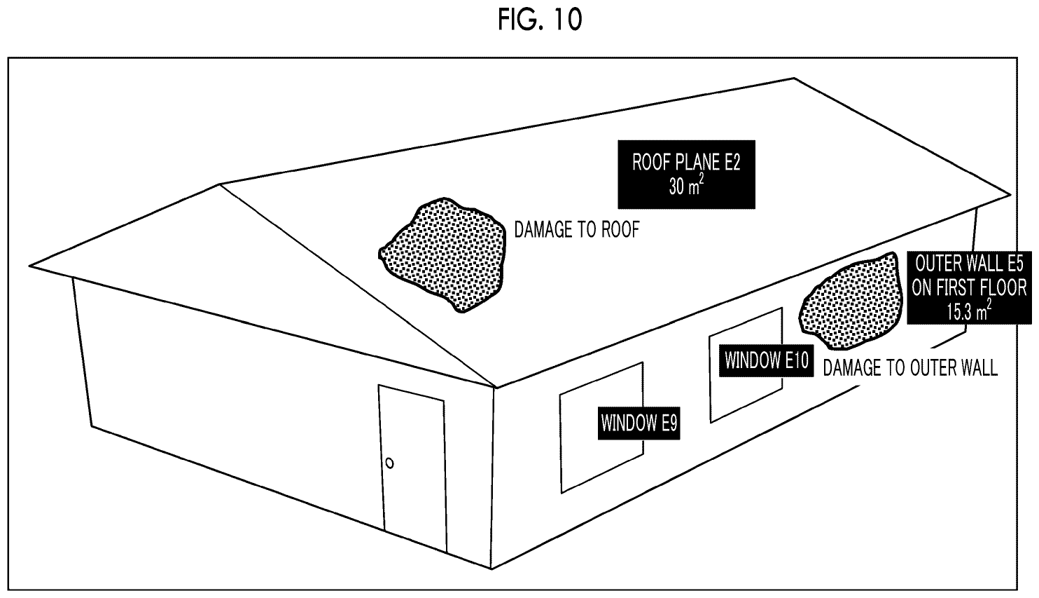

FIG. 10 is a diagram showing an appearance of the building in a case where the roof and the exterior wall of the building shown in FIG. 1 are damaged.

In FIG. 10, damage to the roof is the breakage of a roof plane E2 having an identifier (E2), and damage to the exterior wall is the peeling of the exterior wall E5 having an identifier (E5). In the building data processing device 100, the inspector can use the operation unit 160 to specify a disaster-stricken building to be surveyed and a damaged part of the disaster-stricken building, input a damage size (1 m×2 m) and a part state (breakage) of the roof plane E2, and input a damage size (1 m×2 m) and a part state (peeling) of the exterior wall E5.

In a case where the processor 110 receives an input of the damage size (1 m×2 m) and the part state (breakage) of the roof plane E2, the processor 110 stores the damage size (1 m×2 m) and the part state (peeling) of the roof plane E2 in the building data of the disaster-stricken building, which is stored in the memory 120, as state information indicating the state of the damaged part (roof plane E2) in association with the building data. Similarly, in a case where the processor 110 receives an input of the damage size (2 m×1 m) and the part state (peeling) of the exterior wall E5, the processor 110 stores the damage size (2 m×1 m) and the part state (peeling) of the exterior wall E5 in the building data of the disaster-stricken building as state information indicating the state of the damaged part (exterior wall E5).

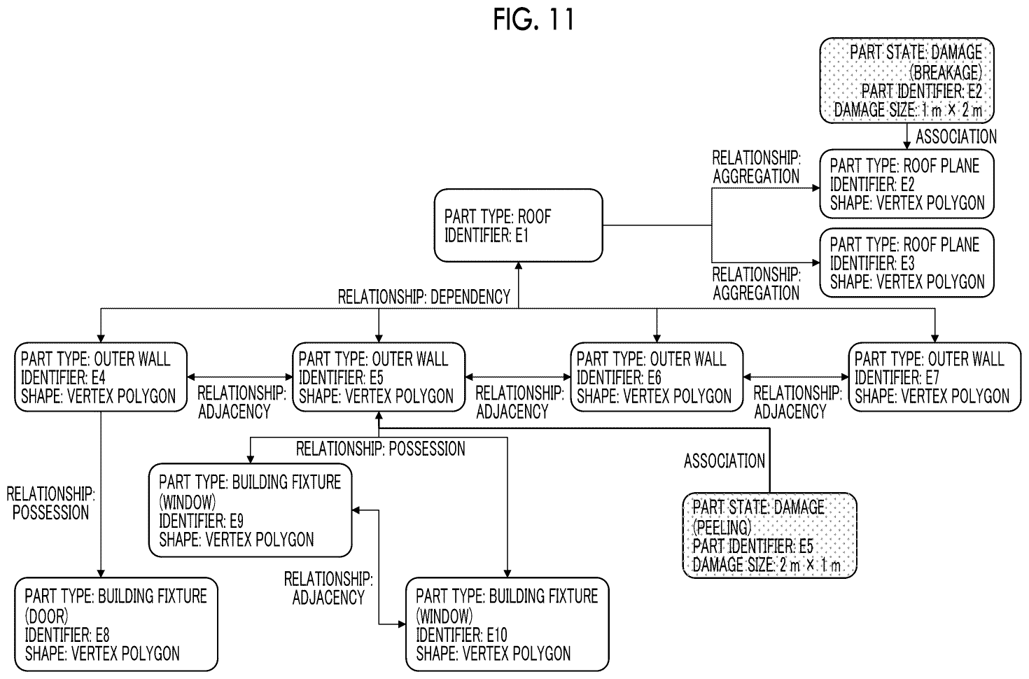

FIG. 11 is a diagram showing the building data structure in which the state information of the part acquired subsequently is associated with the building data structure shown in FIG. 2. The state information of the part acquired subsequently is state information including the damage size (1 m×2 m) and the part state (breakage) of the roof plane E2 and state information including the damage size (2 m×1 m) and the part state (peeling) of the exterior wall E5, as described in FIG. 10.

The processor 110 of the building data processing device 100 converts updated building data having a graph structure of the disaster-stricken building, which is stored in the memory 120, into a JavaScript Object Notation (JSON) file, and transmits the JSON file to the server 200 via the network 202.

Further, the inspector can image the damaged part with a camera and input a damage image to the building data processing device 100. The processor 110 stores the input damage image in the memory 120 in association with the damaged part as the state information of the damage part in the building data of the building to be surveyed. An image file in which the damage image is recorded can be transmitted to the server 200 in association with the JSON file.

Next, a case where the disaster-stricken building is displayed on a remote building data processing device 100 will be described.

In a case where the building data processing device 100 receives the input of an instruction to specify a disaster-stricken building via the operation unit 160, the building data processing device 100 requests the server 200 to transmit the JSON file of the disaster-stricken building and the server 200 transmits the JSON file of the corresponding disaster-stricken building to the building data processing device 100 in response to a transmission request.

The processor 110 of the building data processing device 100 restores a building information graph from the received JSON file and causes the display unit 140 to display the drawing of the disaster-stricken building. In the present example, the building data having the graph structure is converted into a JSON file and the JSON file is transmitted and received. However, a file format to be converted is not limited to the JSON file and may be another text format file.

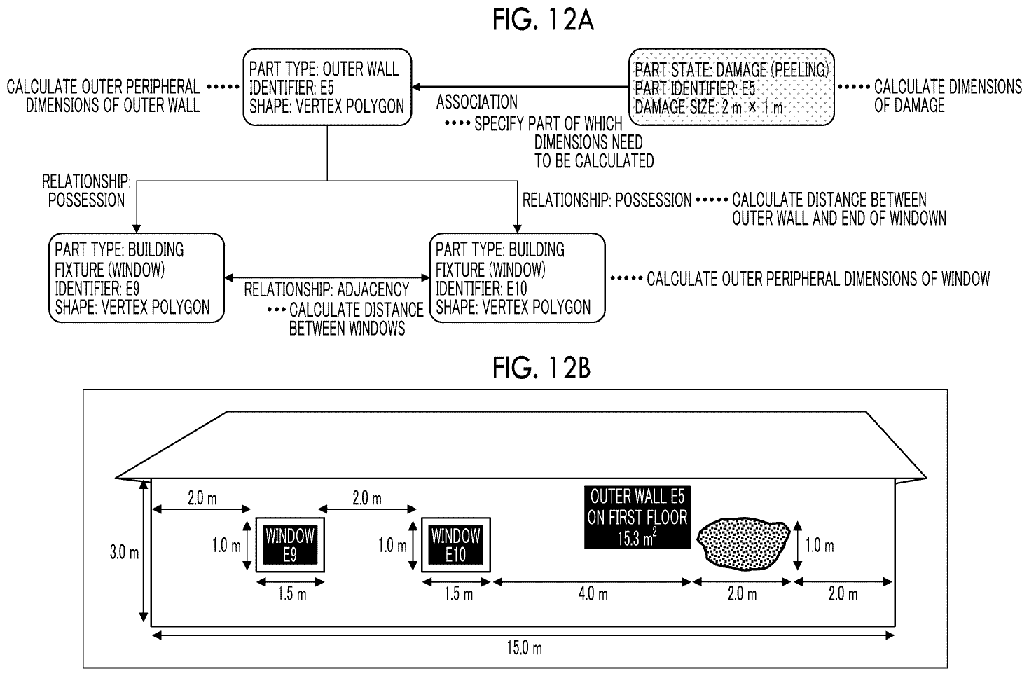

FIGS. 12A and 12B are diagrams showing an example of building data and a drawing of a building displayed based on the building data, and particularly show a case where a damaged part is displayed.

The processor 110 acquires the part identifier (E5) from the part state (damage (peeling)), which indicates a damaged portion, as shown in FIG. 12A to specify the part (the exterior wall E5) of which dimensions need to be calculated, and specifies parts (two windows E9 and E10 having identifiers (E9 and E10)), which are in the possession relationship, using part relationship information (in the present example, the possession relationship) that is traced from the specified exterior wall E5. The processor 110 acquires part information of each of the specified parts (the exterior wall E5, the window E9, and the window E10).

The processor 110 executes required dimension calculation processing according to the part information of each part and the type of the relationship between the parts.

The processor 110 calculates a distance between a left end of the exterior wall E5 and a left end of the window E9 based on shape information (polygon data) of the exterior wall E5 and the window E9 and polygon data appropriately extracted from a relationship (possession relationship) between the exterior wall E5 and the windows E9 and E10. That is, the processor 110 calculates a distance between the left end of the exterior wall E5 and the left end of the window E9 from a difference between polygon data that indicates three-dimensional data of the left end in FIG. 12B in polygon data of the exterior wall E5 and polygon data that indicates three-dimensional data of the left end in FIG. 12B in polygon data of the window E9.

Similarly, the processor 110 calculates outer peripheral dimensions of the windows E9 and E10 based on the polygon data of the windows E9 and E10, respectively, and calculates a distance between the windows E9 and E10 based on polygon data extracted from a relationship (adjacency relationship) between the windows E9 and E10.

On the other hand, the damage size (in the present example, 2 m×1 m) of damage (peeling) of the exterior wall E5 is input by the inspector, but the damage area and the area ratio are calculated by the processor 110.

In a case where the damage image is associated with the exterior wall E5, the damage image can be pasted on the drawing of the exterior wall E5 as described in FIG. 6.

The processor 110 calculates a distance (2 m) between a right end of the damage of the exterior wall E5 and a right end of the exterior wall E5 in FIG. 12B, based on damage information (the damage size and the position data of the damage) of the exterior wall E5 and the polygon data of the exterior wall E5, and calculates a distance (4 m) between a right end of the window E10 and a left end of the damage, based on the polygon data of the window E10 and the damage information (the damage size and the position data of the damage).

The processor 110 can calculate the required distances (dimensions) in the damaged part (exterior wall E5) in this way, and causes the display unit 140 to display the required distances.

### Method of Calculating Floor Area

In the fixed property tax survey service, there are a centerline area and a net floor area as a method of calculating a floor area that is the basis for the calculation of tax.

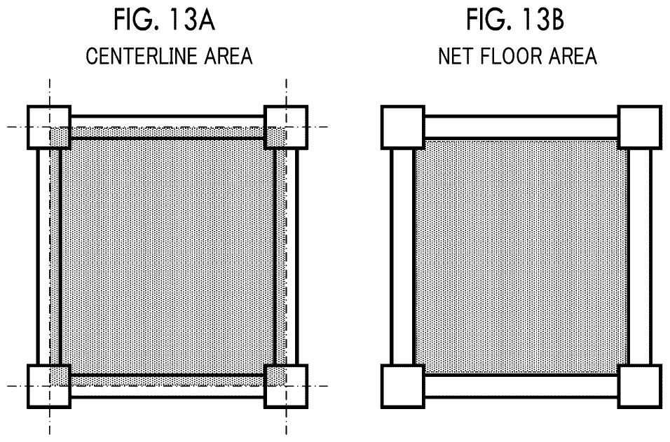

FIGS. 13A and 13B are conceptual diagrams showing a centerline area and a net floor area, in which FIG. 13A shows the centerline area and FIG. 13B shows the net floor area.

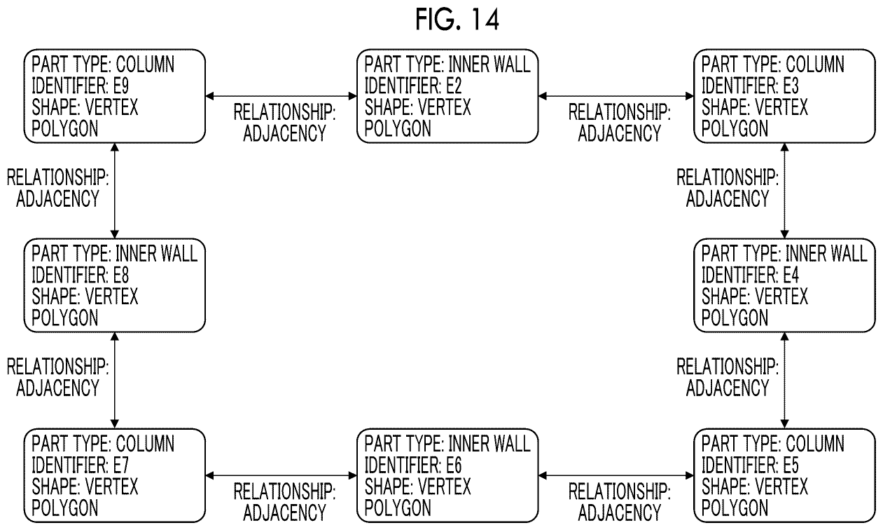

FIG. 14 is a diagram in which a building including four columns and interior walls shown in FIGS. 13A and 13B is modeled based on the part information and the part relationship information.

In FIG. 14, the building including four columns and interior walls comprises four columns E3, E5, E7, and E9 having identifiers (E3, E5, E7, and E9) and four interior walls E2, E4, E6, and E8 having identifiers (E2, E4, E6, and E8).

From the part relationship information indicating a relationship (adjacency relationship) between each of the columns E3, E5, E7, and E9 and each of the interior walls E2, E4, E6, and E8, it is found that the interior wall E2 is provided between the columns E9and E3, the interior wall E4 is provided between the columns E3 and E5, the interior wall E6is provided between the columns E5 and E7, and the interior wall E8 is provided between the columns E7 and E9.

In the following description, it is possible to output calculation results corresponding to each purpose in a case where different types of calculation are specified for one model shown in FIG. 14 in two purposes of use of the calculation of a centerline area and the calculation of a net floor area.

### Example of Calculation of Centerline Area

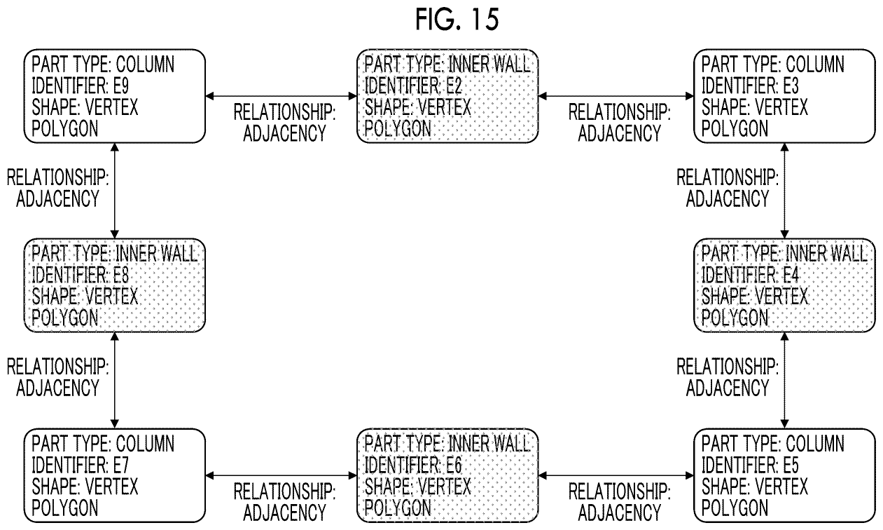

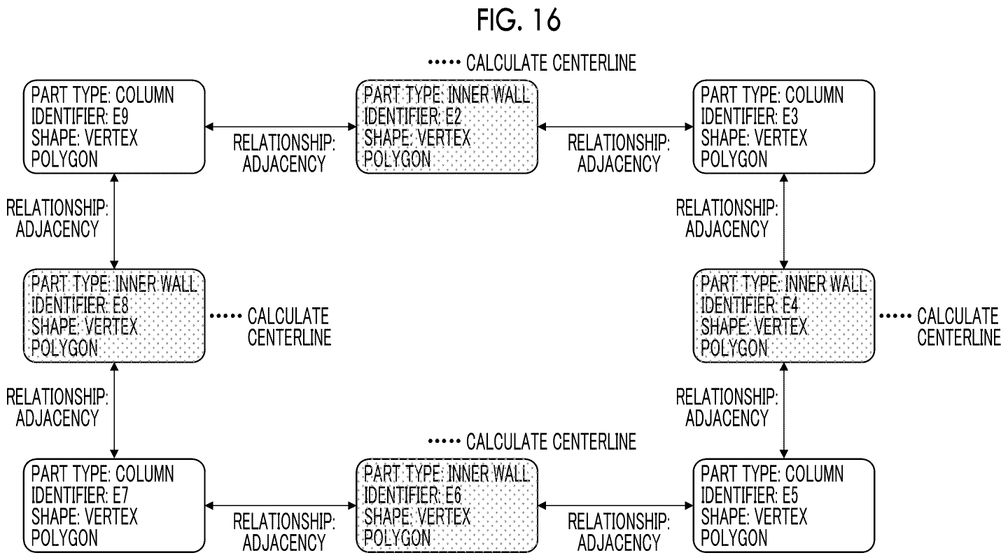

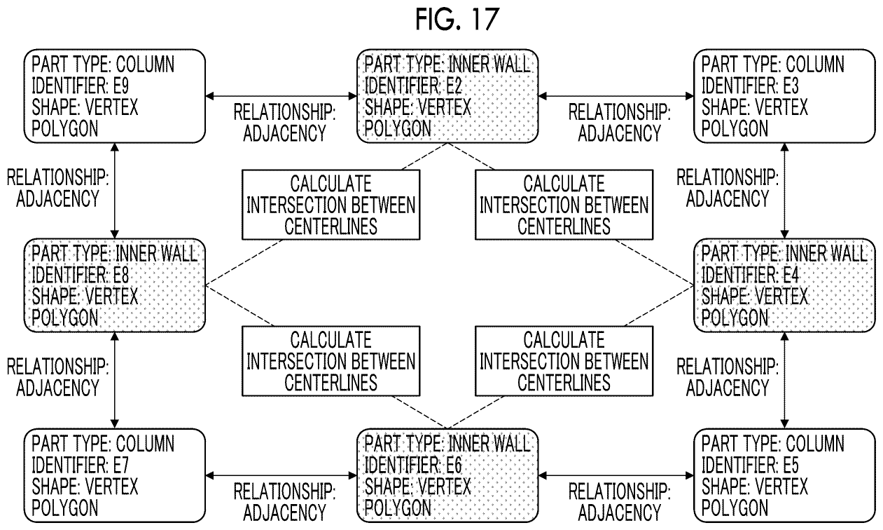

FIGS. 15 to 17 are conceptual diagrams showing examples of a procedure for calculating a centerline area, respectively.
(1) As shown in FIG. 15, interior walls forming a floor area are extracted. The processor 110 searches for a closed circuit that can be traced using part relationship information in which a relationship is “adjacency relationship”, and acquires part information of the interior walls E2, E4, E6, and E8 included in the closed circuit.
(2) As shown in FIG. 16, the processor 110 calculates a centerline of each interior wall based on the part information (vertex polygon) of the four interior walls E2, E4, E6, and E8.
(3) As shown in FIG. 17, the processor 110 specifies pairs of adjacent interior walls using the part relationship information of the “adjacency relationship” and calculates intersections between the centerlines of the pairs.
(4) The processor 110 calculates an area from coordinates of the four intersections calculated in (3). The floor area calculated in this way is the centerline area shown in FIG. 13A.

### Example of Calculation of Net Floor Area

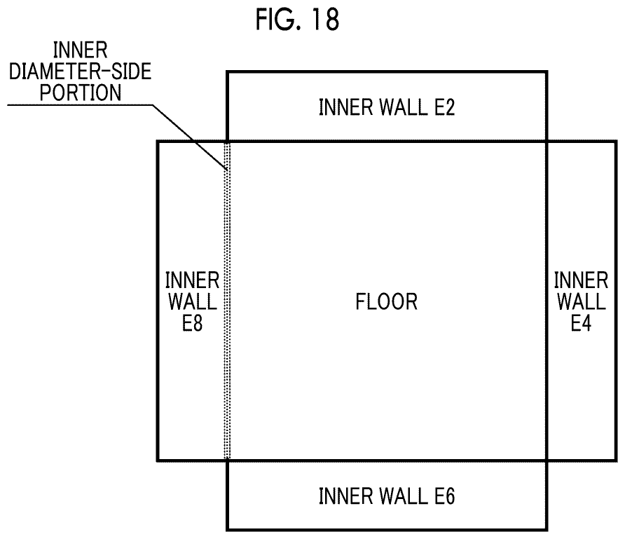

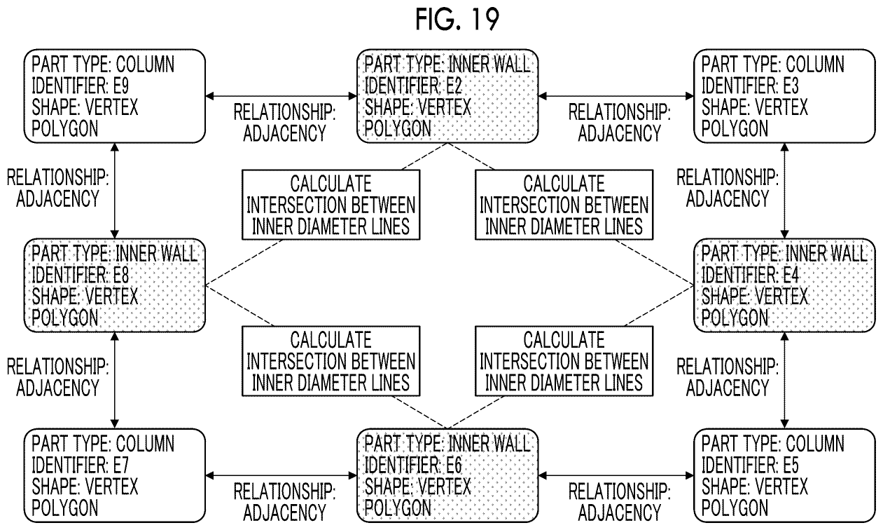

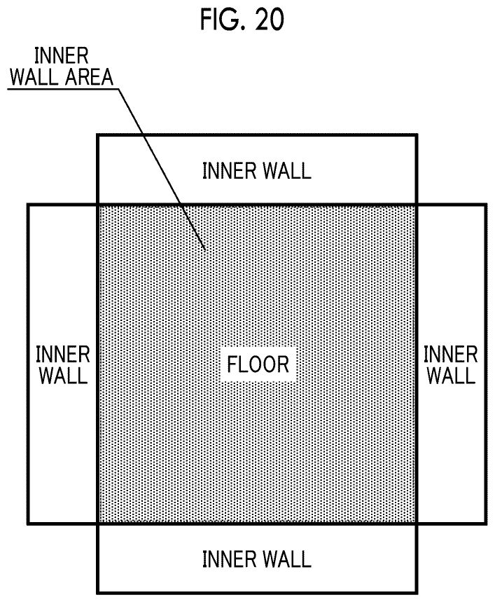

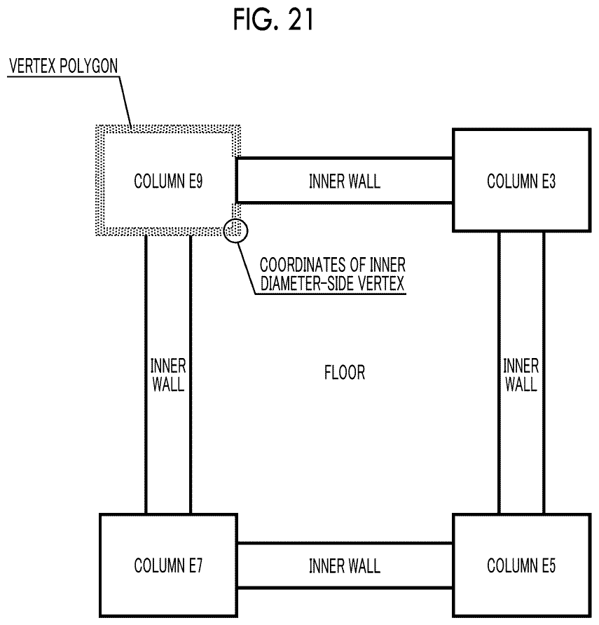

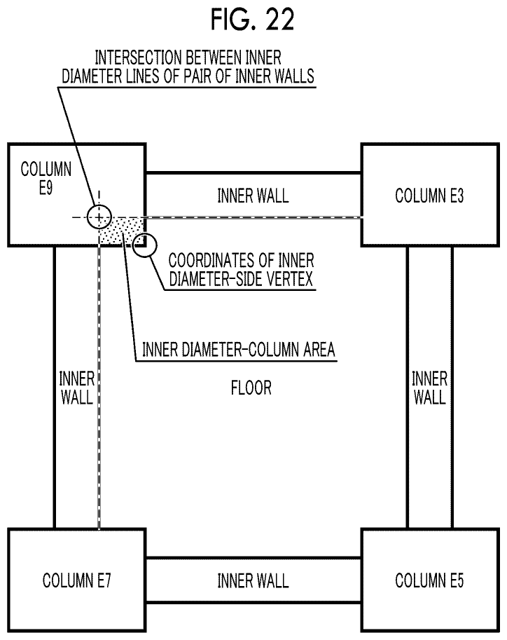

FIGS. 18 to 22 are diagrams showing examples of a procedure for calculating a net floor area, respectively.
(1) FIG. 18 is a schematic diagram showing interior walls forming the floor area. In FIG. 18, the processor 110 extracts the interior walls E2, E4, E6, and E8 forming the floor area and acquires the part information of the interior walls E2, E4, E6, and E8, as in (1) of “the calculation of a centerline area”.
(2) As shown in FIG. 18, the processor 110 calculates an inner diameter-side line segment of a closed circuit for each of the interior walls E2, E4, E6, and E8 from the vertex polygon of the part information.
(3) As shown in FIG. 19, the processor 110 specifies pairs of adjacent interior walls using the part relationship information of the “adjacency relationship” and calculates coordinates of intersections between inner diameter lines of the pairs.
(4) As shown in FIG. 20, the processor 110 calculates an interior wall area based on the coordinates of the intersections between the four inner diameter lines calculated in (3).
(5) The processor 110 extracts parts (four columns E3, E5, E7, and E9) interposed in the “adjacency relationship” from the “adjacency relationship” of the pairs of interior walls specified in (3), and acquires the part information of the columns E3, E5, E7, and E9. The processor 110 acquires coordinates of an inner diameter-side vertex of each of the columns E3, E5, E7, and E9 from the vertex polygon included in the part information of the columns E3, E5, E7, and E9 as shown in FIG. 21.
(6) As shown in FIG. 22, the processor 110 calculates an inner diameter-column area of each of the columns E3, E5, E7, and E9 from the coordinates of the inner diameter-side vertices of the respective columns E3, E5, E7, and E9 acquired in (5) and the coordinates of the intersections between the four inner diameter lines of the pairs of interior walls calculated in (3). The coordinates of the inner diameter-side vertex of the column and the coordinates of the intersection between the inner diameter lines are the coordinates of opposite vertices of a rectangle of the inner diameter-column, a difference between x-coordinates (coordinates in a horizontal direction in FIG. 22) of coordinates of two vertices is a horizontal length of the rectangle of the inner diameter-column, and a difference between y-coordinates (coordinates in a vertical direction in FIG. 22) is a vertical length of the rectangle of the inner diameter-column. Therefore, the inner diameter-column area can be calculated from a product of the vertical length and the horizontal length of the rectangle of the inner diameter-column.
(7) The processor 110 subtracts a total value of the inner diameter-column areas of the four columns E3, E5, E7, and E9 calculated in (6) from the interior wall area calculated in (4) to calculate the net floor area shown in FIG. 13B.

### Building Data Processing Method According to Embodiment

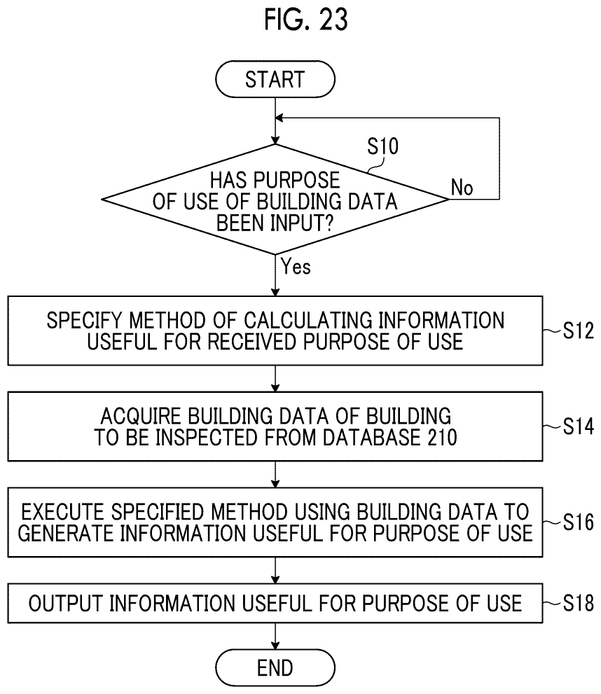

FIG. 23 is a flowchart showing a building data processing method according to an embodiment of the present invention.

The building data processing method shown in FIG. 23 is a method performed by the building data processing device 100 shown in FIG. 3.

In FIG. 23, the processor 110 determines whether or not the purpose of use of the building data has been input from the operation unit 160 (Step S10). In a case where the input of the purpose of use of the building data is received (in a case of “Yes”), the processor 110 specifies a method of calculating information useful for the purpose of use based on the received purpose of use (Step S12). The purpose of use of the building data includes one or more purposes of a residence damage certification survey service, a fixed property tax survey service, an urban planning service, and a vacant house management service. Even in the same purpose of a service, there may be a case where it is effective that a method of calculating the same part information is switched since criteria can be changed due to the amendment or the like of relevant statutory provisions for the service.

Subsequently, the processor 110 acquires building data of a building to be surveyed from the server 200 in response to an instruction input from the operation unit 160, and temporarily stores the building data in the memory 120 (Step S14). The building data is as described in the building data processing device 100 according to the embodiment, and a detailed description thereof will be omitted here.

The processor 110 executes the calculation method specified in Step S12 using the part information and the part relationship information of the respective parts included in the building data stored in the memory 120 to generate information useful for the purpose of use (Step S16).

The processor 110 can output the information useful for the purpose of use, which is generated in this way, to the display unit 140 and/or the memory 120, and store the information in association with the identifier of the corresponding part of the building data stored in the memory 120 (Step S18).

That is, the processor 110 can execute the modeling tool using the building data to cause the display unit 140 to display the drawings of one or a plurality of parts that are desired by a user. In a case where the processor 110 receives, for example, the input of the purpose of the residence damage certification survey service as the purpose of use of the building data, the processor 110 calculates the dimensions and the area of each part based on the shape information (vertex polygon) of the part for each part of the disaster-stricken building and causes the display unit 140 to display calculation results. In a case where the processor 110 receives the input of the dimensions of damage through the inspector's operation of the operation unit 160, the processor 110 calculates a damage area (m²) and an area ratio (a ratio of the damage area to the area of the part) (%) and causes the display unit 140 to display the damage area and the area ratio.

Further, in a case where the processor 110 receives, for example, the input of the purpose of the fixed property tax survey service as the purpose of use of the building data, the processor 110 calculates the floor area of the building to be surveyed for the fixed property tax assessment using the part information and the part relationship information of the respective parts included in the building data.

A method of calculating a centerline area, a method of calculating a net floor area, and the like are available as a method of calculating a floor area as shown in FIGS. 13A and 13B, and the processor 110 calculates information (floor area) effective for fixed property tax assessment according to the calculation method specified in Step S12.

Further, in a case where a time-series relationship is included as the part relationship information and the processor 110 receives the switching of the history from the extension/reconstruction history displayed on the display unit 140, the processor 110 can cause the display unit 140 to display the part and the state information based on the part information associated with the switched history. Furthermore, the processor 110 can calculate a floor area of a newly constructed building or a floor area after extension/reconstruction using the part information and the part relationship information corresponding to the part displayed on the display unit 140.

### Others

The building data processing system including one or a plurality of building data processing devices 100, 100-1, and the like, which are clients, and the server 200 has been described as an example in the present embodiment, but the building data processing device according to the embodiment of the present invention may store building data in a database or a memory provided in the building data processing device to independently perform building data processing.

In the present embodiment, for example, the hardware structure of a processing unit that executes various types of processing, such as a central processing unit (CPU), includes various processors to be described below. The various processors include: a CPU that is a general-purpose processor functioning as various processing units by executing software (programs); a programmable logic device (PLD) that is a processor of which the circuit configuration can be changed after manufacture, such as a field programmable gate array (FPGA); a dedicated electrical circuit that is a processor having a circuit configuration designed exclusively to perform specific processing, such as an application specific integrated circuit (ASIC); and the like.

One processing unit may be configured of one of these various processors, or may be configured of two or more processors of the same type or different types (for example, a plurality of FPGAs or a combination of a CPU and an FPGA). Further, a plurality of processing units may be configured of one processor. As an example where a plurality of processing units are configured of one processor, first, there is an aspect where one processor is configured of a combination of one or more CPUs and software as typified by a computer, such as a client or a server, and functions as a plurality of processing units. Second, there is an aspect where a processor fulfilling the functions of the entire system, which includes a plurality of processing units, using one integrated circuit (IC) chip as typified by System On Chip (SoC) or the like is used. As described above, various processing units are formed using one or more of the above-described various processors as hardware structures.

In addition, the hardware structures of these various processors are more specifically electrical circuitry where circuit elements, such as semiconductor elements, are combined.

Further, it goes without saying that the present invention is not limited to the above-described embodiments and can have various modifications without departing from the scope of the present invention.

### EXPLANATION OF REFERENCES

10: building
11: roof
12: exterior wall
13: exterior wall
14: door
15, 16: window
100: building data processing device
110: processor
112: calculation method-specifying unit
114: display control unit
116: information generation unit
120: memory
130: database
140: display unit
150: input/output interface
160: operation unit
200: server
202: network
210: database
S10: Step
S12: Step
S14: Step
S16: Step

What is claimed is:

1. A building data processing device comprising:
a memory that stores building data including identifiers, part information, and part relationship information, the identifiers being used to identify a plurality of parts constituting a building, the part information consisting of part types indicating types of the plurality of parts associated with the identifiers, respectively, shape information indicating three-dimensional shapes of the plurality of parts, and state information indicating states of the plurality of parts, and the part relationship information indicating a relationship between the plurality of parts; and
a processor,
wherein the processor is configured to:
receive an input of a purpose of use of the building data;
specify a method of calculating information useful for the purpose of use based on the received purpose of use; and
execute the specified method using the part information and the part relationship information stored in the memory to generate information useful for the purpose of use.

2. The building data processing device according to claim 1,
wherein the part types include information indicating one or more parts of an exterior wall, an interior wall, a roof, a foundation, a column, a beam, a floor, a ceiling, a building fixture, and equipment.

3. The building data processing device according to claim 1,
wherein the part relationship information includes information indicating one or more relationships of an aggregation relationship that indicates a relationship between a first part and a second part of a substructure of the first part, a dependency relationship that indicates a relationship between a first part and a second part in a case where the first part depends on a structure of the second part, an adjacency relationship that indicates a relationship between a first part and a second part in a case where the first part and the second part of the same type are adjacent to each other, a possession relationship that indicates a relationship between a first part and a second part in a case where the first part possesses the second part as a component, and a time-series relationship that is related to a history of the same part associated with extension/reconstruction.

4. The building data processing device according to claim 1,
wherein the state information includes a damage type, a damage size, a degree of damage, a flood depth, an inspector comment, or an image.

5. The building data processing device according to claim 1,
wherein the building data of a building to be surveyed includes information on a disaster-stricken building that has been struck by a disaster in a vicinity of the building to be surveyed.

6. The building data processing device according to claim 1,
wherein the purpose of use includes one or more purposes of a residence damage certification survey service, a fixed property tax survey service, an urban planning service, and a vacant house management service.

7. The building data processing device according to claim 1,
wherein the processor is configured to store the generated information in the memory in association with the identifiers corresponding to the parts as the state information of the parts.

8. The building data processing device according to claim 1,
wherein the processor is configured to:
specify a method of calculating building damage information useful for a residence damage certification survey service of a building received as the purpose of use of the building data in a case where the processor receives the residence damage certification survey service as the purpose of use of the building data;
receive an input of an instruction to display or not display each part of the building and cause a display unit to display the part for which the input of the instruction is received, dimensions of the part, and the state information; and
execute the specified method using the part information and the part relationship information corresponding to the part displayed on the display unit to generate building damage information that is the state information.

9. The building data processing device according to claim 8,
wherein the building damage information includes information indicating a damage image, a damage size, a ratio of an area occupied by damage, or a flood depth.

10. The building data processing device according to claim 9,
wherein the processor is configured to receive a degree of damage, which is input by a user, for each damage, and
the building damage information includes the degree of damage.

11. The building data processing device according to claim 1,
wherein the processor is configured to:
specify a method of calculating a floor area useful for a fixed property tax survey service of a building received as the purpose of use of the building data in a case where the processor receives the fixed property tax survey service as the purpose of use of the building data;
cause a display unit to display an extension/reconstruction history of the building based on a time-series relationship included in the part relationship information;
cause the display unit to display the part and the state information based on the part information associated with a switched history in a case where the processor receives switching of a history from the extension/reconstruction history displayed on the display unit; and
execute the specified method of calculating the floor area using the part information and the part relationship information corresponding to the part displayed on the display unit to generate the floor area that is the state information.

12. A building data processing method executed by a processor of a building data processing device including a memory that stores building data including identifiers, part information, and part relationship information, the identifiers being used to identify a plurality of parts constituting a building, the part information consisting of part types indicating types of the plurality of parts associated with the identifiers, respectively, shape information indicating three-dimensional shapes of the plurality of parts, and state information indicating states of the plurality of parts, and the part relationship information indicating a relationship between the plurality of parts, and a processor, the building data processing method comprising:
a step of receiving an input of a purpose of use of the building data;
a step of specifying a method of calculating information useful for the purpose of use based on the received purpose of use; and
a step of executing the specified method using the part information and the part relationship information stored in the memory to generate information useful for the purpose of use.

13. The building data processing method according to claim 12, further comprising:
a step of receiving a residence damage certification survey service of a building as the purpose of use of the building data;
a step of specifying a method of calculating building damage information useful for the received residence damage certification survey service;
a step of receiving an input of an instruction to display or not display each part of the building and causing a display unit to display the part for which the input of the instruction is received, dimensions of the part, and the state information; and
a step of executing the specified method using the part information and the part relationship information corresponding to the part displayed on the display unit to generate building damage information that is the state information.

14. The building data processing method according to claim 12, further comprising:
a step of receiving a fixed property tax survey service of a building as the purpose of use of the building data;
a step of specifying a method of calculating a floor area useful for the received fixed property tax survey service;
a step of causing a display unit to display an extension/reconstruction history of each part of the building based on a time-series relationship included in the part relationship information;
a step of causing the display unit to display the part and the state information based on the part information associated with a switched history in a case where switching of a history is received from the extension/reconstruction history displayed on the display unit; and
a step of executing the specified method of calculating the floor area using the part information and the part relationship information corresponding to the part displayed on the display unit to generate the floor area that is the state information.

15. A building data structure comprising:
identifiers that are used to identify a plurality of parts constituting a building;
part information that consists of part types indicating types of the plurality of parts associated with the identifiers, respectively, shape information indicating three-dimensional shapes of the plurality of parts, and state information indicating states of the plurality of parts; and
part relationship information that indicates a relationship between the plurality of parts,
wherein the building data structure is represented as a valid graph in which the part information corresponds to nodes and the part relationship information corresponds to edges.

16. The building data structure according to claim 15,
wherein the part types include information indicating one or more parts of an exterior wall, an interior wall, a roof, a foundation, a column, a beam, a floor, a ceiling, a building fixture, and equipment.

17. The building data structure according to claim 15,
wherein the part relationship information includes information indicating one or more relationships of an aggregation relationship that indicates a relationship between a first part and a second part of a substructure of the first part, a dependency relationship that indicates a relationship between a first part and a second part in a case where the first part depends on a structure of the second part, an adjacency relationship that indicates a relationship between a first part and a second part in a case where the first part and the second part of the same type are adjacent to each other, a possession relationship that indicates a relationship between a first part and a second part in a case where the first part possesses the second part as a component, and a time-series relationship that is related to a history of the same part associated with extension/reconstruction.

18. The building data structure according to claim 15,
wherein the state information includes a damage type, a damage size, a degree of damage, a flood depth, an inspector comment, or an image.
